(19) United States
(12) Patent Application Publication
(10) Pub. No.: US 2012/0210151 A1
(43) Pub. Date: Aug. 16, 2012

(54) COMMUNICATION SYSTEMS

(75) Inventors: Tung-Yi Wang, Pan-Chiao City (TW); Hao-Jung Li, Zhubei City (TW)

(73) Assignee: MEDIATEK INC., Hsin-Chu (TW)

(21) Appl. No.: 13/339,682

(22) Filed: Dec. 29, 2011

Related U.S. Application Data
(60) Provisional application No. 61/441,749, filed on Feb. 11, 2011.

(51) Int. Cl. G06F 1/32

(52) U.S. Cl. 713/320

(57) ABSTRACT

A communication system is provided and includes a current control circuit, a processing module, and a detection circuit. The current control circuit has an output node. The current control circuit is capable of drawing input current to the output node. The processing module is capable of operating according to a current accumulated at the output node and an output voltage at the output node. The detection circuit is capable of detecting the output voltage and controlling the processing module according to a detection result of the detection circuit. When the detection circuit detects that the output voltage is lower than a threshold, the detection circuit is capable of controlling the processing module to decrease an output power of a power amplifier or to decrease an operating frequency of a processor.

### CROSS REFERENCE TO RELATED APPLICATIONS

This application claims the benefit of U.S. Provisional Application No. 61/441,749, filed on Feb. 11, 2011, the contents of which are incorporated herein by reference.

### BACKGROUND OF THE INVENTION

1. Field of the Invention

The invention relates to a communication system, and more particularly to a mobile communication system which can handle heavy loading.

2. Description of the Related Art

FIG. 1 shows a conventional mobile communication system, such as a USB data card. Referring to FIG. 1, a mobile communication system 1 includes a current limiter 11, a capacitor 12, a DC-to-DC converter 13, a power amplifier 14, and a processor 15. The mobile communication system 1 is coupled to a host through an input/output (I/O) port 10 (such as a USB port). The conventional mobile communication system 1 does not include a battery and uses the capacitor 12 to imitate a battery instead. The current limiter 11 draws current Iin from the host through the I/O port 10, and the amount of the current drawn from the host is limited by the current limiter 11. The current accumulated at an output node N11 of the current limiter 11 is stored in the capacitor 12. The DC-to-DC converter 13 is used to lower a level of voltage V11 at the output node N11 of the current limiter 11 for operation of the power amplifier 14 and the processor 15.

FIG. 2 shows variation of key current and voltage of the conventional mobile communication system of FIG. 1 when a heavy loading condition occurs. In FIG. 2, V10 represents the voltage provided from the host through the I/O port 10, V11 represents the voltage at the output node N11, and V13 represents the voltage at the output node of the DC-to-DC converter 13. Referring to FIG. 2, when a heavy loading condition occurs, such as the power amplifier 14 requires a large current to operate in the period P10, the current drawn from the capacitor 12 is not enough. Moreover, the amount of the current drawn from the host is limited by the current limiter 11. Thus, the voltage V11 drops, which may induce resetting of the mobile communication system 1. In order to prevent the resetting condition, the capacitor 12 may have large capacitance or be implemented by a large number of capacitors, however, if so, the area and cost of the mobile communication system 1 would increase.

Thus, it is desired to provide a communication system to solve the above problems.

### BRIEF SUMMARY OF THE INVENTION

An exemplary embodiment of communication system comprises a current control circuit, a processing module, and a detection circuit. The current control circuit has an output node. The current control circuit is capable of drawing an input current to the output node. The processing module is capable of operating according to a current accumulated at the output node and an output voltage at the output node. The detection circuit is capable of detecting the output voltage and controlling the processing module according to a detection result of the detection circuit.

When the detection circuit detects that the output voltage is lower than a first threshold, the detection circuit is capable of controlling the processing module to adjust an operation state. In an embodiment, the processing module comprises a power amplifier. When the detection circuit detects that the output voltage is lower than the first threshold, the detection circuit is capable of controlling the processing module to decrease an output power of the power amplifier.

In another embodiment, the processing module comprises a processor. When the detection circuit detects that the output voltage is lower than the first threshold, the detection circuit is capable of controlling the processing module to decrease an operating frequency of the processor.

Another exemplary embodiment of a communication system comprises a current control circuit, and a processing module. The current control circuit has an output node. The current control circuit is capable of drawing an input current to the output node. The processing module is capable of operating according to a current accumulated at the output node and an output voltage at the output node. The current control circuit is further capable of detecting the output voltage and adjusting an amount of the input current according to a detection result.

The current control circuit comprises a tracking circuit capable of detecting the output voltage. When the tracking circuit detects that the output voltage is lower than a first threshold, the tracking circuit is capable of increasing the amount of the input current. In an embodiment, the input current is drawn from an input/output (I/O) port, and the tracking circuit is further capable of detecting an input voltage at an input node of the current control circuit. When the tracking circuit detects that the input voltage is lower than a second threshold, the tracking circuit is capable of stopping increasing the amount of the input current drawn from the I/O port. In another embodiment, when the tracking circuit detects that the input voltage is lower than the second threshold, the tracking circuit is capable of controlling the current control circuit to stop drawing the input current drawn from the I/O port.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a conventional mobile communication system;

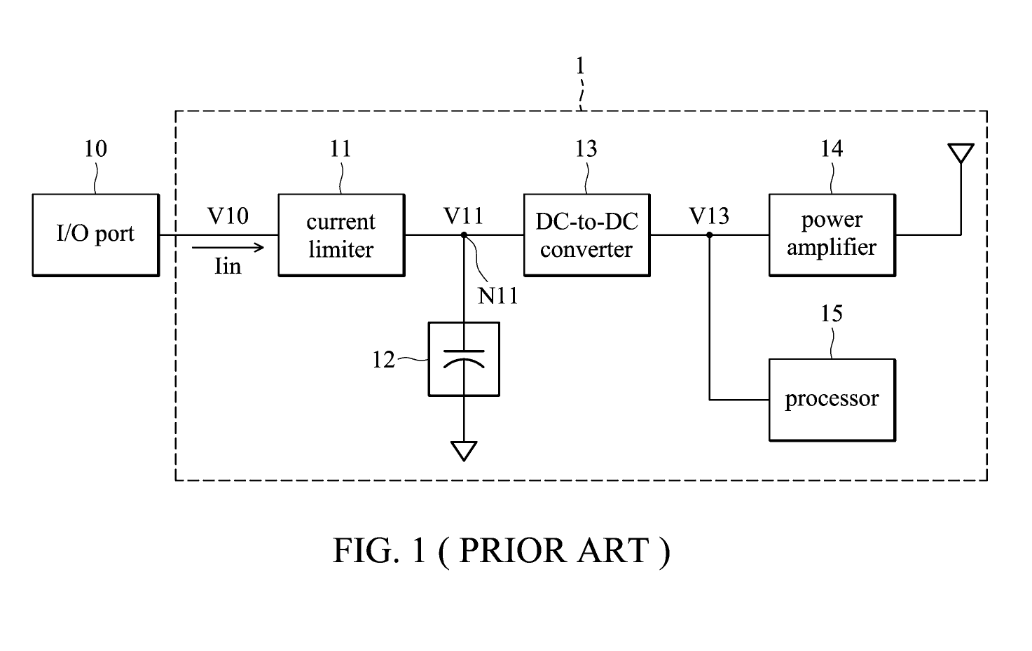

FIG. 2 shows variation of key current and voltage of the conventional mobile communication system of FIG. 1 when a heavy loading condition occurs;

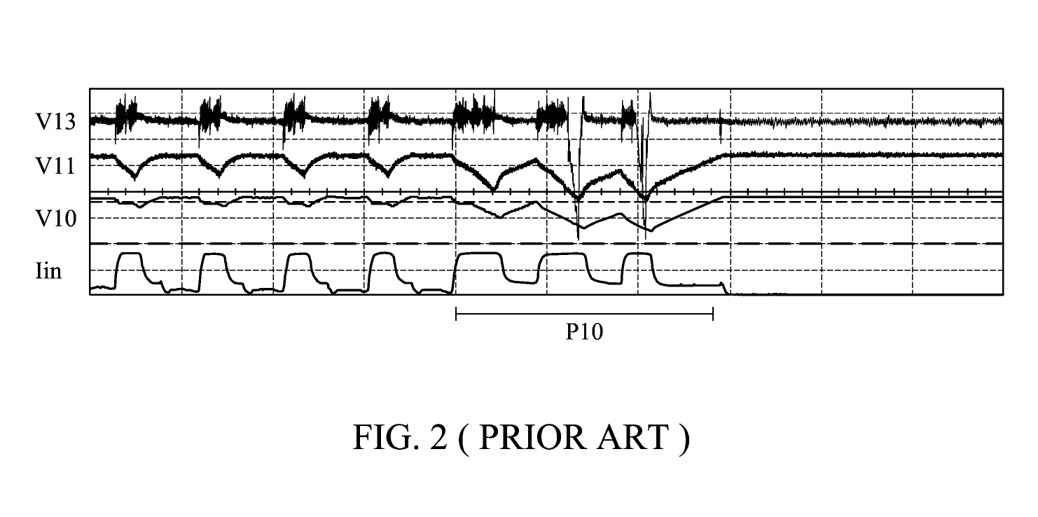

FIG. 3 shows an exemplary embodiment of a communication system connected to a host through an input/output port;

FIG. 4 shows another exemplary embodiment of a communication system connected to a host through an input/output port; and

FIG. 5 shows further another exemplary embodiment of a communication system connected to a host through an input/output port.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

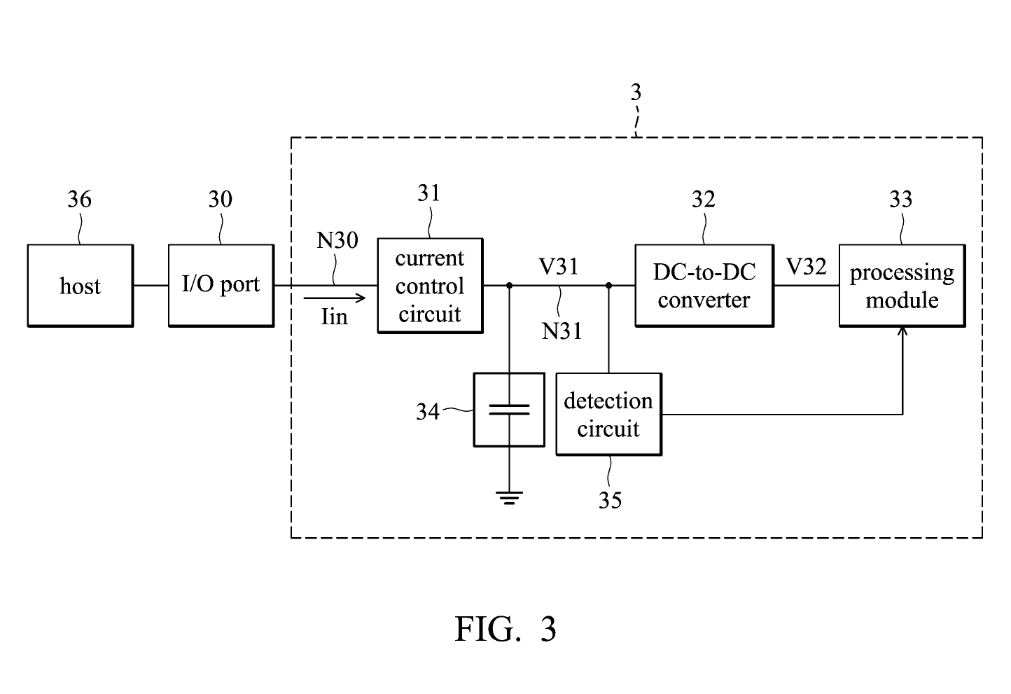

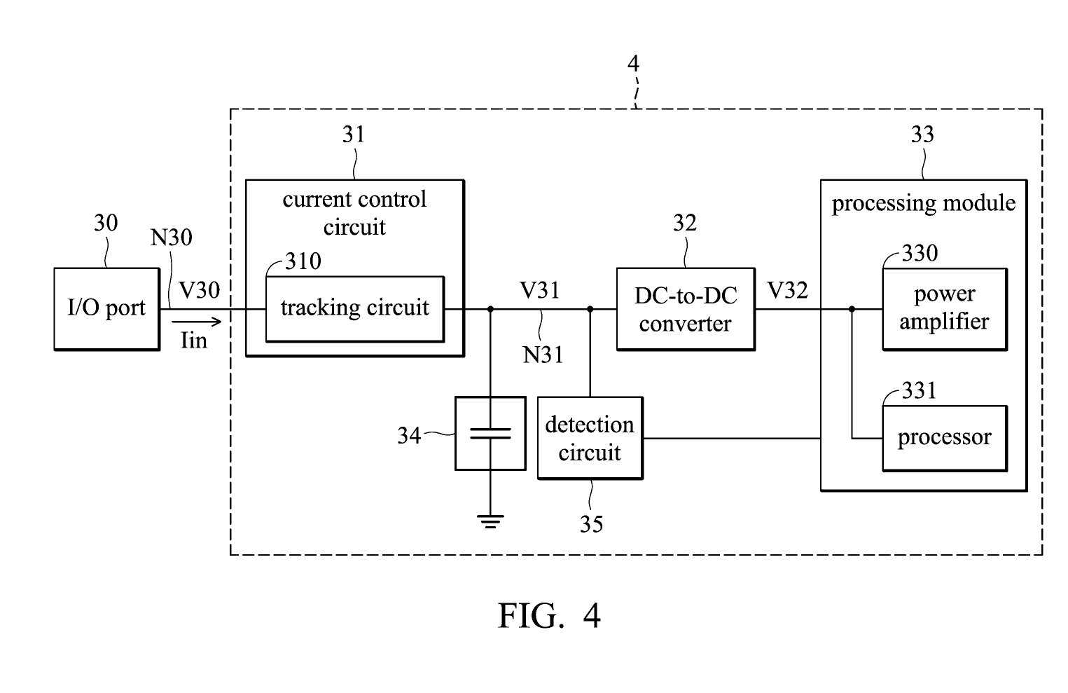

In an exemplary embodiment of a communication system in FIG. 3, a communication system 3 can include a current control circuit 31, a DC-to-DC converter 32, a processing module 33, a capacitor 34, and a detection circuit 35. The detection circuit 35 may be an analog-to-digital converter. In some embodiments, the detection circuit 35 can be integrated into the processing module 33. The communication system 3 may be connected to a host 35 through an input/output (I/O) port 30. The host 36 is capable providing current to peripheral systems. The current control circuit 31 has an input node N30 and an output node N31. When the communication system 3 is coupled to the host 36 through the I/O port 30, the current control circuit 31 which is coupled to the I/O port 30 can draw an input current Iin from the I/O port 30 to the output node N31. The current Iin drawn from the I/O port 30 can be accumulated at the output node N31 and stored in the capacitor 34, and accordingly, an output voltage V31 is generated at the output node N31. The DC-to-DC converter 32 is capable of receiving the output voltage V31 and changing a level of the output voltage V31 to generate an output voltage V32. In the embodiment, the DC-to-DC converter 32 is a buck converter which is capable of lowering the level of the output voltage V31. The processing module 33 is coupled to the DC-to-DC converter 32 and is capable of operating according to the current accumulated at the output node N31 and the output voltage V32 with the lowered level. The detection circuit 35 is capable of detecting the output voltage V31 and controlling the processing module 33 according to the detection result. When one operation unit of the processing module 33 requires a large current for operation, a large amount of current is drawn from the output node N31, wherein the large amount of current includes the current stored in the capacitor 34 and the current being drawn from the host 36 through the I/O port 30. At this time, due to the large amount of current being drawn from the output node N31, the output voltage V31 may drop. When the detection circuit 35 detects that the output voltage V31 is lower than a threshold Vth1, the detection circuit 35 is capable of controlling the processing module 33 to adjust an operation state of the operation unit in the processing module 33, thereby prevent the communication system 1 from being reset. FIG. 4 shows another exemplary embodiment of the communication system 4 with the current control circuit 31 and processing module 33. Referring to FIG. 4, in this embodiment, the current control circuit 31 includes a tracking circuit 310 capable of detecting the output voltage V31 and adjusting an amount of the input current Iin according to a detection result of the tracking circuit 310. The processing module 33 may include at least one operation unit. In the embodiment of FIG. 4, the processing module 33 includes a power amplifier 330 and a processor 331, serving as operation units, which may require large currents for operations in some conditions. In a case, when the power amplifier 330 requires a large current for operation, the output voltage V31 may drop due to the large amount of current drawn from the output node N31. During this period, when the detection circuit 35 detects that the output voltage V31 has dropped to be lower than the threshold Vth1, the detection circuit 35 is capable of controlling the processing module 33 to decrease an output power of the power amplifier 330. In another case, when the processor 331 requires a large current for operation, the output voltage V31 may drop due to the large amount of current drawn from the output node N31. During this period, when the detection circuit 35 detects that the output voltage V31 has dropped to be lower than the threshold Vth1, the detection circuit 35 is capable of controlling the processing module 33 to decrease an operating frequency of the processor 331. Thus, in the embodiment, by decreasing the output power of the power amplifier 330 or the operating frequency of the processor 331, the communication system 4 can be prevented from being reset due to the drop in output voltage V31.

In the embodiment, the amount of the current drawn from the host, such as the host 36 in FIG. 3, can be adjusted to deal with the requirement of a large current for the operation units of the processing module 33. The tracking circuit 310 of the current control circuit 31 is also capable of detecting the output voltage V31. When one operation unit, such as the power amplifier 330 or the processor 331, requires a large current for operation, the output voltage V31 may drop due to the large amount of current being drawn from the output node N31. When the tracking unit 310 detects that the output voltage V31 is lower than a threshold Vth2, the tracking circuit 310 is capable of increasing the amount of the input current Iin drawn from the I/O port 30. The threshold Vth2 can be higher than, equal to or lower than the threshold Vth1 according to different design requirements. However, the current control circuit 31 cannot draw an infinite amount of current from the host, such as the host 36 in FIG. 3, through the I/O port 30. This is because, excessively drawing out current from the host may cause the host to be reset or make a warning announcement. Thus, the tracking circuit 310 of the current control circuit 31 is further capable of detecting an input voltage V30 at an input node N30 of the current control circuit 31. In a case, when the tracking circuit 310 detects that the input voltage V30 is lower than a threshold Vth3, the tracking circuit 310 is capable of stopping increasing the amount of the input current Iin drawn from the I/O port. At this time, the tracking circuit 310 can keep the amount of the input current Iin the same or contrarily decrease the amount of the input current Iin to a value at which the input voltage V30 is not lower than the threshold Vth3, wherein the threshold Vth3 is equal to or larger than the threshold Vth1. In another case, when the tracking circuit 310 detects that the input voltage V30 is lower than the threshold Vth3, the tracking circuit 310 is capable of controlling the current control circuit 31 to stop drawing the input current from the I/O port. Accordingly, by the detection of the input voltage V30, the current control circuit 31 will not excessively draw current from the host, thus can prevent the host, such as the host 36 in FIG. 3, from being reset or making a warning announcement.

According to the embodiment of FIG. 4, when one operation unit of the processing module 33 requires a large current, the detection unit 35 can control the processing module 33 to adjust the operation state of the operation unit. Moreover, the current control circuit 31 can appropriately increase the amount of the input current Iin from the host through the I/O port 30 to deal with the requirement of a large current, while the host 36 can still operate normally at the same time. Accordingly, it is not necessary to implement the capacitor 34 with a large number of capacitors or large capacitance, and the communication system 4 can operate normally when the requirement for a large current appears.

In the embodiment, the threshold Vth3 for the detection of the input voltage V30 can be determined according to the specification of the host, such as the host 36 in FIG. 3, connected with the communication system 4. When the host is capable of providing a larger current to peripheral systems, the threshold Vth3 is set at a lower level, and when the host 36 is capable of providing less current to peripheral systems, the threshold Vth3 is set at a higher level. Thus, when one operation unit of the processing module 33 requires a large current, the communication system 4 can draw more current from a host which is capable of providing a larger current to peripheral systems.

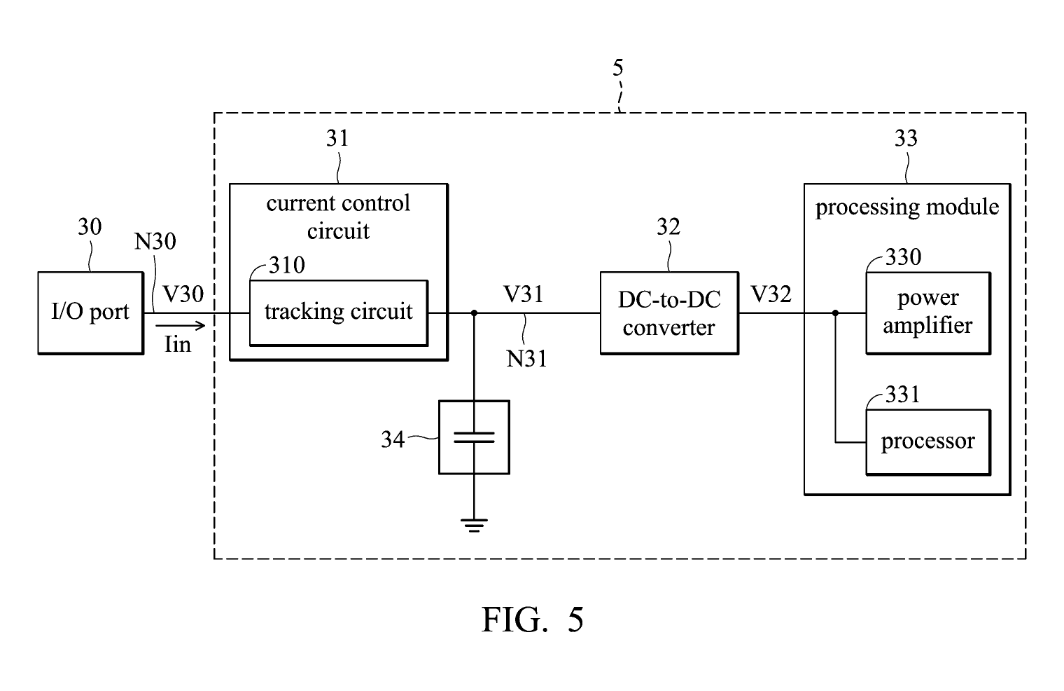

FIG. 5 shows another embodiment of a communication system. Referring to FIG. 5, compared with the embodiment of FIG. 4, the communication system 5 performs the detection of the output voltage V31 by only the tracking circuit 310. In FIGS. 4 and 5, the similar units are labeled by the similar references and capable of performing the similar operations. When one operation unit, such as the power amplifier 330 or the processor 331, requires a large current for operation, the output voltage V31 may drop due to the large amount of current being drawn from the output node N31. When the tracking unit 310 detects that the output voltage V31 is lower than the threshold Vth2, the tracking circuit 310 is capable of increasing the amount of the input current Iin drawn from the I/O port 30. However, the current control circuit 31 cannot draw an infinite amount of current from the host, such as the host 36 in FIG. 3, through the I/O port 30 without limitation. This is because, excessively drawing a current from the host may cause the host to be reset or make a warning announcement. Thus, the tracking circuit 310 of the current control circuit 31 is further capable of detecting the input voltage V30 at the input node N30 of the current control circuit 31. In a case, when the tracking circuit 310 detects that the input voltage V30 is lower than a threshold Vth3, the tracking circuit 310 is capable of stopping increasing the amount of the input current Iin drawn from the I/O port 30. At this time, the tracking circuit 310 can keep the amount of the input current Iin the same or contrarily decrease the amount of the input current Iin to a value at which the input voltage V30 is not lower than the threshold Vth3. In another case, when the tracking circuit 310 detects that the input voltage V30 is lower than the threshold Vth3, the tracking circuit 310 is capable of controlling the current control circuit 31 to stop drawing the input current from the I/O port 30. Accordingly, by the detection of the input voltage V30, the current control circuit 31 cannot excessively draw current from the host, thus can prevent the host 30 from being reset or making a warning announcement.

According to the embodiment of FIG. 5, when one operation unit of the processing module 33 requires a large current, the current control circuit 31 can appropriately increase the amount of the input current Iin from the host through the I/O port 30 to deal with the requirement of a large current, and the host 36 can still operate normally at the same time. Accordingly, it is not necessary to implement the capacitor 34 with a large number of capacitors or large capacitance, and the communication system 5 can operate normally when the requirement for a large current appears.

In some embodiment, each of the detection circuit 35 and the tracking circuit 310 may be implemented by hardware, software, firmware, or the combination thereof. In the above embodiments, the communication systems 3, 4 and 5 do not have to be installed with a substantial battery. Each of the communication systems 3, 4 and 5 can be implemented by a system which is capable of being coupled to a host through an I/O port, such as a USB data card or any portable device having communication capability, such as portable TV, Wi-Fi dongle, Bluetooth dongle, etc.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A communication system comprising:
a current control circuit, having an output node and capable of drawing an input current to the output node;
a processing module capable of operating according to a current accumulated at the output node and an output voltage at the output node; and
a detection circuit capable of detecting the output voltage and controlling the processing module according to a detection result of the detection circuit.

2. The communication system as claimed in claim 1, wherein when the detection circuit detects that the output voltage is lower than a first threshold, the detection circuit is capable of controlling the processing module to adjust an operation state.

3. The communication system as claimed in claim 2, wherein the processing module comprises a power amplifier, and when the detection circuit detects that the output voltage is lower than the first threshold, the detection circuit is capable of controlling the processing module to decrease an output power of the power amplifier.

4. The communication system as claimed in claim 2, wherein the processing module comprises a processor, and when the detection circuit detects that the output voltage is lower than the first threshold, the detection circuit is capable of controlling the processing module to decrease an operating frequency of the processor.

5. The communication system as claimed in claim 1, wherein the detection unit is capable of controlling the processing module to adjust an operation state of the processing module so as to prevent the communication system from being reset.

6. The communication system as claimed in claim 1 further comprising a capacitor capable of storing the current accumulated at the output node.

7. The communication system as claimed in claim 1, wherein the communication system is not installed with a battery.

8. The communication system as claimed in claim 1, wherein the current control circuit comprises a tracking circuit capable of detecting the output voltage and adjusting an amount of the input current according to a detection result of tracking circuit.

9. The communication system as claimed in claim 8, wherein when the tracking circuit detects that the output voltage is lower than a first threshold, the tracking circuit is capable of increasing the amount of the input current.

10. The communication system as claimed in claim 9, wherein the input current is drawn from an input/output (I/O) port, the tracking circuit is further capable of detecting an input voltage at an input node of the current control circuit and stopping increasing the amount of the input current drawn from the I/O port when the tracking circuit detects that the input voltage is lower than a second threshold.

11. The communication system as claimed in claim 9, wherein the input current is drawn from an input/output (I/O) port, the tracking circuit is further capable of detecting an input voltage at an input node of the current control circuit and controlling the current control circuit to stop drawing the input current from the I/O port when the tracking circuit detects that the input voltage is lower than a second threshold.

12. The communication system as claimed in claim 1, wherein the communication system is implemented by a USB data card which is capable of being coupled to a host through an input/output (I/O) port.

13. A communication system comprising:
a current control circuit, having an output node and capable of drawing an input current to the output node; and
a processing module capable of operating according to a current accumulated at the output node and an output voltage at the output node,
wherein the current control circuit is further capable of detecting the output voltage and adjusting an amount of the input current according to a detection result.

14. The communication system as claimed in claim 13, wherein the current control circuit comprises a tracking circuit capable of detecting the output voltage and increasing the amount of the input current when the tracking circuit detects that the output voltage is lower than a first threshold.

15. The communication system as claimed in claim 14, wherein the input current is drawn from an input/output port, the tracking circuit is further capable of detecting an input voltage at an input node of the current control circuit and stopping increasing the amount of the input current drawn from the I/O port when the tracking circuit detects that the input voltage is lower than a second threshold.

16. The communication system as claimed in claim 14, wherein the input current is drawn from an input/output (I/O) port, the tracking circuit is further capable of detecting an input voltage at an input node of the current control circuit and controlling the current control circuit to stop drawing the input current from the I/O port when the tracking circuit detects that the input voltage is lower than a second threshold.

17. The communication system as claimed in claim 13, wherein the current control circuit is further capable of adjusting the amount of the input current so as to prevent the communication system from being reset.

18. The communication system as claimed in claim 13 further comprising a capacitor capable of storing the current accumulated at the output node.

19. The communication system as claimed in claim 13, wherein the communication system is not installed with a battery.

20. The communication system as claimed in claim 13, wherein the communication system is implemented by a USB data card which is capable of being coupled to a host through an input/output (I/O) port.
